(19) United States
(12) Patent Application Publication
(10) Pub. No.: US 2019/0368239 A1
(43) Pub. Date: Dec. 5, 2019

(54) HANDLE DEVICE

(71) Applicant: HUF HÜLSBECK & FÜRST GMBH & CO. KG, Velbert (DE)

(72) Inventors: Michael Rhein, Mönchengladbach (DE); Bernd Reifenberg, Essen (DE)

(21) Appl. No.: 16/341,420

(22) PCT Filed: Aug. 17, 2017
(86) PCT No.: PCT/EP2017/070875

§ 371 Date: Apr. 11, 2019

(30) Foreign Application Priority Data
Oct. 12, 2016 (DE) 10 2016 119 423.9

(51) Int. Cl. E05B 81/90; E05B 85/10; E05B 85/06; E05B 81/76

(52) U.S. Cl. CPC E05B 81/90; E05B 85/103; E05B 81/76; E05B 85/06; E05B 85/107

(57) ABSTRACT

The invention concerns a handle device (1) for a movable part (100), in particular a door, of a motor vehicle, comprising a handle device (10) for actuating the movable part (100) and a support element (20), on which the handle device (10) is movably mounted between a rest position (I) and an operating position (II), wherein in the rest position (I) the handle device (10) can be arranged with an outer surface (10a) flush with an outer surface (100a) of the movable part (100), wherein, in the operating position (II), the handle device (10) can be moved out of an opening (101) in the outside (100a) of the movable part (100), wherein, in the operating position (II), the handle device (10) can be actuated in order to open the movable part (100), and wherein the support element (20) has a first bearing position (21) and a second bearing position (22) for the handle device (10).

The invention related to a handle device for a movable part, in particular a door, of a motor vehicle according to the generic term of the independent device claim, which is provided with a handle device for actuating the movable part, a support element, on which the handle device is movably mounted between a rest position and an operating position, wherein in the rest position the handle device can be arranged with an outer surface flush with an outer side of the movable part, wherein in the operating position the handle device can be moved out of an opening in the outer side of the movable part, wherein in the operating position the handle device can be actuated to open the movable part, and wherein the support element has a first bearing position and a second bearing position for the handle device. Furthermore, the invention concerns a corresponding method according to the generic term of the independent method claim.

Handle devices for movable parts, in particular doors, of a motor vehicle with flush handle devices are generally known. A support element on which a handle device is mounted movably between at least two positions, namely a rest position, in which the handle device can be arranged flush with an outer surface to an outside of the movable part, and an operating position, in which the handle device can be moved out of an opening in the outside of the movable part so that the handle device can be actuated to open the movable part in the operating position, is usually used for fastening such handle devices to the movable part. A first bearing position and a second bearing position are provided at the end of the support element for the movable bearing of the handle section. With such gripping devices there is often no space in the area of the two bearing points to accommodate a mechanical emergency locking cylinder for a mechanical actuation of a locking system of the motor vehicle. There is therefore a risk that in an emergency, e.g. in the event of an accident, if the vehicle's electronics fail, the vehicle's locking system cannot be unlocked either automatically or mechanically. In the worst case, first aid can then be provided too late.

It is therefore the object of the present invention to create a handle device for a movable part of a motor vehicle, in particular a door, which at least partially overcomes one of the above-mentioned disadvantages. In particular, it is the object of the invention to provide a compact handle device that ensures improved, safer operation of a vehicle locking system, particularly in an emergency.

In order to solve the above object, a handle device with the features of the main claim, in particular with the features from the characterizing part, and a method with the features of the independent method claim are proposed. Further advantageous embodiments of the invention result from the dependent claims, the description and the drawings. In the dependent device and method claims, preferred further developments of the invention are listed. Characteristics which are disclosed to the device conforming to the invention also apply to the process conforming to the invention and vice versa.

The proposed handle device can be used for various movable parts of the vehicle, such as motor vehicle doors on the driver's and passenger's sides, rear doors or trunk lid and doors. An emergency can be considered for example an accident, an electronic failure, a short circuit, a dangerous lateral position, excessive acceleration or the like. In such a case, it may be important to mechanically unlock the movable part to allow access to a vehicle interior, for example by an assistant or an emergency helper.

For this purpose, the invention provides for a locking cylinder for mechanically unlocking the movable part at least in an emergency, which can be brought into a mechanical operative connection with a locking system of the motor vehicle, the locking cylinder being mounted on the support element between the first bearing position and the second bearing position.

The invention idea is to provide a locking cylinder for a mechanical emergency release of a locking system of the motor vehicle, also in the handle devices, in which there is no space on the support element at the first bearing position and at the second bearing position for the handle device in order to arrange the locking cylinder. For this reason, in the present invention the mechanical locking cylinder is arranged in the grip area of the flush handle device, i.e. between the two bearings of the handle device. This provides a handle device that is compact and yet highly secure, with the handle device reliably enabling mechanical emergency unlocking of the vehicle's locking system. To make it easier to insert an emergency key into the lock cylinder, the lock cylinder can be positioned at an angle to the outside of the door so that the emergency key can be guided past the handle device in the pulled position with a minimum gap of 1 mm. The locking cylinder can be concealed behind the handle in the rest position. In order to expose the locking cylinder and make it accessible from the outside, the handle device can be released from the rest position in the direction of the operating position, for example by actuating a sensor element on the handle device, or transferred to an intermediate position in which the handle device can be transferred to the actuating position by a first pull movement. In the operating position of the handle, the locking cylinder can be operated by an emergency key to unlock the locking system of the motor vehicle. The handle can then open the door with a second pull. Advantageously, the invention enables improved, safer operation of the vehicle's locking system, especially in an emergency. This ensures that first aid can be provided on time in the event of an emergency.

The invention may also provide for the locking system to be configured as a keyless go system or a keyless entry system. According to both alternatives, corresponding sensors, e.g. non-contact proximity sensors such as capacitive sensors or pressure sensors, can be integrated in the handle device. Furthermore, it is conceivable that a security system for the locking system with a corresponding transmitting and receiving unit for an identification interrogation can be fully or partially integrated in the handle device. It is advantageous that such a locking system can normally lock and/or unlock the vehicle door without a mechanical locking cylinder if the user's authorization has been verified. Then such a locking system can automatically transfer the handle device into the actuating position in order to be able to open the movable part by pulling on the handle device. Thus, an automated locking system can be provided for the vehicle. Such locking systems may provide for the locking system to automatically unlock all movable parts or vehicle doors in an emergency situation. However, if the electronics or power supply of such a locking system should fail, a mechanical locking cylinder is available for emergency unlocking according to the invention. The advantage is therefore that, despite an accident or a power failure, the invention still creates the possibility of operating the vehicle's locking system as an alternative, in particular mechanically.

The invention may also provide for the locking cylinder to be positioned in such a way that in the rest position of the handle device the locking cylinder is covered by the handle device and may be inaccessible from the outside. In addition, the locking cylinder can be mounted in such a way that in the operating position of the handle the locking cylinder can be exposed by the handle and operated from the outside. In order to release the handle from the rest position in the direction of the operating position, a sensor element, e.g. a pressure sensor, can first be actuated at the right end of the handle, preferably at the end, so that the handle can then be transferred to the operating position by pulling. In the operating position of the handle, it may be advantageous for the locking cylinder to be exposed and operated by an emergency key in order to unlock the locking system of the motor vehicle. The door can then be opened by pulling the handle further. This enables a handle which, in the rest position of the handle device, can meet high demands in terms of configuration and aerodynamics and which, in the operating position of the handle device, can enable mechanical operation of the motor vehicle closing system and intuitive operation of the movable device in order to open the movable device.

Furthermore, the invention may provide that the locking cylinder may be mounted at an angle to the outside of the movable device, in particular on the support element. This ensures that despite a lack of space, even in the operating position of the handle, especially between the handle and the locking cylinder, an emergency key can be inserted into the locking cylinder without any complications. The emergency key can also be guided at an angle to the outside of the movable part, preferably past the handle, preferably along an axis of rotation of the locking cylinder. This allows an emergency helper to insert the emergency key easily and conveniently into the locking cylinder, especially with sufficient freedom of movement, even for correction movements.

It is also conceivable that the locking cylinder may have an axis of rotation which may extend at an angle of at least 20°, in particular at least 25°, to a horizontal line which is substantially perpendicular to the outside of the movable part. It has been shown to be advantageous that sufficient space can be provided at an angle of at least 20° to allow an emergency key to be inserted into the locking cylinder without any complications, in particular past the handle. With an angle of approx. 25°, good freedom of movement for inserting the emergency key into the locking cylinder can be provided without difficulties when mounting the locking cylinder in an inclined position on the support element.

The invention may also provide that the locking cylinder may be aligned in such a way that, when inserted into the locking cylinder, an emergency key with a gap of at least 1 mm, and in particular at least 2 mm, can be guided past the handle in the operating position. It is advantageous that the emergency key does not touch the handle when inserted into the locking cylinder and cannot scratch it. With the aid of a correctly adjusted gap, a balance can be ensured between the locking cylinder bearing on the support element being too inclined and the emergency key being easily inserted into the locking cylinder. With a gap of at least 2 mm, sufficient freedom of movement can be created to adjust or correct the insertion direction of the emergency key when inserting it into the locking cylinder.

The invention may also provide for the locking cylinder to be positioned in such a way that an emergency key can perform a rotary movement of at least 1° to 180° when the locking cylinder is actuated. The locking cylinder can be positioned in such a way that an emergency key with a flat side can be guided past the handle device in the operating position and can only be turned in the inserted position. It is therefore advantageous that a first responder does not need to carry out a full rotation of the locking cylinder in order to unlock the locking system. This can facilitate the opening process of the door and allow faster assistance. A rotation of the locking cylinder of at least 1° to 180° is advantageously sufficient to permit stable operation of the locking system of the motor vehicle, e.g. via a gearbox. It is therefore advantageous not to expose the entire face of the locking cylinder in the opening on the outside of the movable part, but only part of it. Consequently, a larger angle between the axis of rotation of the locking cylinder and the horizontal can be provided to improve the accessibility of the locking cylinder. This also allows the gap for inserting the emergency key into the locking cylinder to be enlarged in order to create more freedom of movement for the emergency key.

Furthermore, the invention may provide that the locking cylinder may be positioned in such a way that the locking cylinder can be used exclusively to unlock the locking system of the motor vehicle. This means that the locking cylinder can only be configured for unlocking the locking system in an emergency, but not for normal operation. In normal operation, when all electronic systems and/or sensors in the motor vehicle are functioning correctly, there is no need to use the locking cylinder to lock and/or unlock the locking system of the motor vehicle. This enables simplification of the configuration of the locking cylinder, of the vehicle locking system and, in particular, of a gearbox that can connect the locking cylinder to the vehicle locking system. The construction of the handle device can thus also be improved, in particular simplified. The handle device can thus be made more compact.

Furthermore, the invention may provide that the handle device, preferably adjacent to the second bearing position, may have a sensor element to detect an activation action of a user, in particular an first responder. It can be advantageous that the sensor element can be passive. Furthermore, it is conceivable that the sensor element can be configured as a passive sensor, e.g. a capacitive sensor, a pressure sensor, an inductive sensor, an NFC sensor or an LDC sensor. With a sensor element adjacent to a second bearing position or to a second or right end of the handle section, intuitive operation of the handle section can be provided because a user grips the handle section most of the time at the right end.

Furthermore, the invention may provide that the handle device can be secured to the support element in such a way that, by detecting an activation action of a user, the handle device can be released from the rest position in the direction of the operating position in order to be able to transfer the handle device to the operating position by pulling on the handle device. Thus, the advantage can be achieved that in an emergency, the handle device can be released mechanically, e.g. by a locking mechanism, in order to be transferred into the operating position. By recording a user's activation action, e.g. by pressing, preferably on the right-hand side of the handle device, it can be ensured that the handle device can be released by a conscious activation action in order to be transferred to the operating position.

In addition, a locking mechanism may be provided which, in normal operation of the motor vehicle, can hold the handle device in the rest position and/or connect the handle device to a drive device which, in normal operation, can move the handle device between the rest position and the operating position. The advantage here is that the locking element can be in a locking position during normal operation of the motor vehicle, in which the locking element can ensure that the handle device can be actuated functionally, in particular automatically between the rest position and the operating position. In an emergency, the locking element can be moved to a release position where the locking element can release the handle device from the rest position towards the operating position and/or release the connection of the handle device to a drive device so that the handle device can be prepared for mechanical transfer to the operating position.

Advantageously, the sensor element can be operatively connected to the locking mechanism in order to release the handle device from the resting position in the direction of the operating position in an emergency by detecting an activation action of a user. In other words, the sensor element can be operatively connected to the locking mechanism to, in an emergency, transfer the locking mechanism from a locking position, in which the locking element can hold the handle device in the rest position and/or connect the handle device to a drive device, to a release position, in which the locking element can release the handle device from the rest position towards the operating position and/or disconnect the connection of the handle device to a drive device, by detecting an activation action of a user. This ensures that in an emergency, a conscious activation action of an emergency helper can be detected and can cause the locking mechanism to release the handle device from the rest position in the direction of the operating position and/or release the connection of the handle device to a drive device. This ensures that in an emergency, when the vehicle's electronics fail, a mechanical transfer of the handle device from the rest position to the operating position can take place.

Furthermore, the handle device can be mounted on the support element in such a way that, by sensing an activation action of a user, the handle device can be transferred from the rest position into an intermediate position in which the handle device can be released for transfer into the operating position. An intermediate position can be advantageous in order to hold the handle device securely on the movable part. It is conceivable that in the intermediate position the movable part can still remain closed. Only if an first responder grips the handle device in the intermediate position can the handle device be transferred to the operating position, in which the locking system of the motor vehicle can be mechanically unlocked by means of the locking cylinder, after which the movable part can be opened. This enables conscious, step-by-step and safe operation of the handle device.

The advantage of this is that the handle can tilt between the rest position and the intermediate position, especially outwards. This allows the handle device not to protrude too far from the outside of the movable part in the intermediate position, so that the handle device can be reliably transferred to the intermediate position even if space is limited.

Furthermore, a transmission may be provided to establish a mechanical operative connection between the locking cylinder, even in an inclined position on the support element, and the locking system of the motor vehicle, in particular the mechanism may be self-locking. Advantageously, the mechanism can enable the locking cylinder to be fastened to the support element in an inclined position and still have a stable mechanical active connection to the vehicle locking system. A self-locking mechanism is advantageous to secure the locking cylinder or locking system in an unlocked state and to prevent it from unintentionally falling back into a locked state.

The mechanism may also have a drive wheel, particularly on the axis of rotation of the locking cylinder, and an output wheel. Furthermore, it is conceivable that the output wheel may be operatively connected to the locking system of the motor vehicle. In this way, a mechanical connection between the locking cylinder and the locking system of the vehicle can be provided in a simple and cost-effective manner.

In addition, it is conceivable that the drive wheel and/or the output wheel can be arranged at an angle of at least 20°, in particular at least 25°, to one other. This allows an angular arrangement to be provided between the axis of rotation of the locking cylinder or drive wheel and an output axis of the output wheel. Consequently, the locking cylinder can be placed at an angle to the outside of the movable part and still provide a reliable transmission of action to the vehicle locking system. It is conceivable that the input wheel and/or the output wheel may each have a conical toothing so that the contact surfaces of the teeth on the input wheel and the output wheel can come into full surface contact even at an acute angle. This enable the transfer efficiency with a high degree of efficiency.

Furthermore, the inventive object is solved by a method of emergency actuation of a handle device for a movable part, in particular a door, of a motor vehicle according to the generic term of the method claim, wherein the handle device can be configured as described above. Here the handle device is having a handle device for actuating the movable part, a support element on which the handle device is mounted movably between a rest position and an operating position, wherein in the rest position the handle device can be arranged with an outer surface flush with an outer side of the movable part, wherein in the operating position the handle device can be moved out of an opening in the outer side of the movable part, the handle device being operable in the operating position to open the movable part, and the support element having a first bearing position and a second bearing position for the handle device, and a locking cylinder for unlocking the movable part at least in an emergency, which can be brought into a mechanical operative connection with a locking system of the motor vehicle. The method according to the invention comprises the following steps:
a) Detecting an activation action of a user on the handle device to release the handle device from the rest position towards the operating position,
b) Gripping the handle device,
c) Pull the handle device to move the handle device to the operating position,
d) Inserting an emergency key into the locking cylinder to unlock the movable part.

By detecting an activation action of a user, e.g. by pressing, preferably on the right side, on the handle device, it can be ensured that the handle device can be released by a conscious activation action in order to be transferred to the operating position. By gripping and pulling on the handle device, the handle device can be conveniently transferred to the operating position. In the operating position of the handle device, the locking cylinder can be advantageously exposed from the handle area of the handle device, which was previously covered by the handle area of the handle device in the rest position of the handle device. Finally, with the help of an emergency key, the locking cylinder can be operated to mechanically unlock the vehicle's locking system. According to the invention therefore enables the motor vehicle to operate the locking system intuitively and easily, particularly in an emergency. This ensures that first aid is ensured in a timely manner in the event of an emergency. In addition, according to the invention achieves the same advantages as those previously described in connection with the inventive handle device. In order to avoid repetitions, full reference is made in the present case.

Furthermore, the invention may provide that in step (a) an activation action of a user can be detected by pressing the handle, in particular in the vicinity of the second bearing position. Advantageously, a pressure can be detected by a passive sensor element, which does not have to have electric and can also be actuated in the event of a failure of the vehicle electronics. It is conceivable that the sensor element can be configured as a passive sensor, e.g. a capacitive sensor, a pressure sensor, an inductive sensor, an NFC sensor or an LDC sensor. With a sensor element adjacent to a second bearing position or to a second or right end of the handle device, intuitive operation of the handle device can be provided.

Furthermore, the method may comprise at least one further step:
a1) releasing a locking element which holds the handle device in the rest position and/or establishes a connection of the handle device to a drive device which moves the handle device during a normal operation between the rest position and the operating position.

For this purpose, it may be provided that, during normal operation of the motor vehicle, the locking element can be in a locking position in which the locking element can ensure that the handle device can be operated in accordance with its function, in particular that it can be driven automatically between the rest position and the operating position. In an emergency, the locking element can be moved to a release position in which the locking element can release the handle device from the rest position towards the operating position and/or release the connection of the handle device to a drive device to prepare the handle device for mechanical transfer to the operating position.

Furthermore, the method may include at least one further step:
a2) Transferring the handle device from the rest position to an intermediate position in which the handle device is released for transfer to the operating position,
   wherein, in particular in step a2), the handle device can execute a tilting movement, in particular outwards, from the rest position into the intermediate position. In the intermediate position, it is advantageous to hold the handle device reliably on the movable part. In the intermediate position of the handle device, the movable part can still remain closed. Only if an first responder in step b) grips the handle device in the intermediate position can the handle device in step c) be transferred to the operating position by pulling, in which the locking system of the motor vehicle can be mechanically unlocked in step d), after which the movable part can finally be opened by further pulling on the handle device. In addition, it is conceivable that the handle device can be loaded resiliently into the intermediate position so that it automatically jumps up and/or swivels and/or tilts into the intermediate position after the handle device has been released from the rest position.

The method may also include at least one further step:
e) Pull the handle device to open the movable part.

This enables a first responder to gain access to the vehicle interior in order to be able to provide emergency assistance.

Method steps a) to d), preferably a) to e), may be carried out successively. This enables the movable part to be opened step by step and safely, even when the vehicle is tilted, without there being any risk of the movable part releasing unintentionally.

Further advantageous measures and characteristics of the invention result from the following description as well as the figures shown. In the figures the invention is represented in several execution examples. Show it:

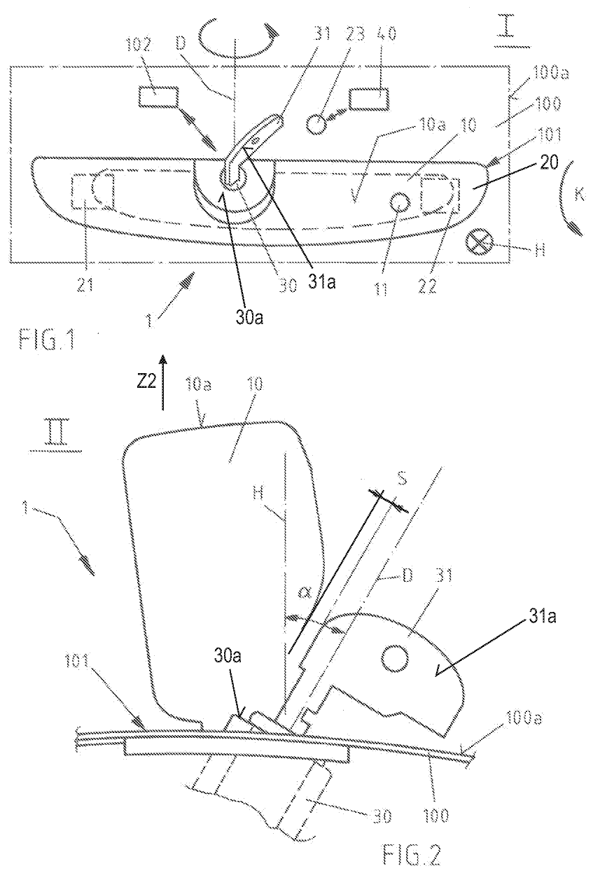

FIG. 1 a top view of the handle device according to the invention with a dashed handle device in a rest position,

FIG. 2 a side view of the handle device according to the invention with the handle device in an operating position,

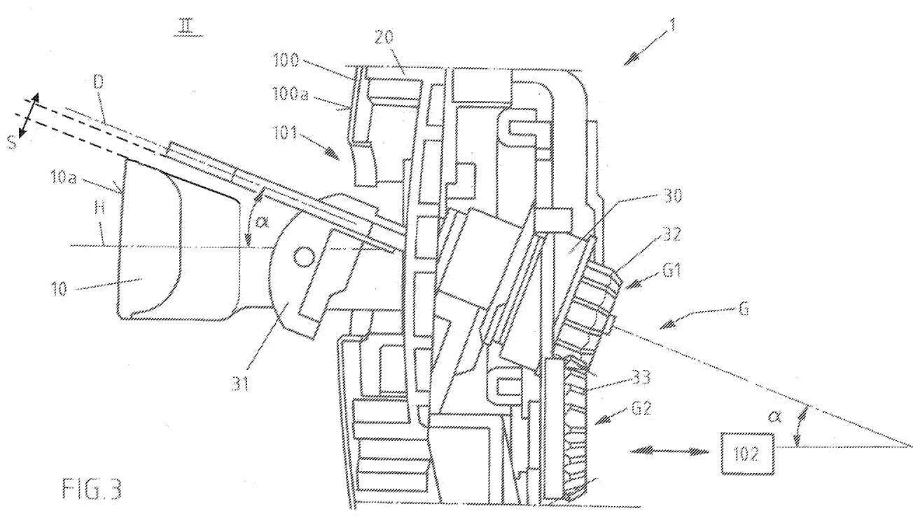

FIG. 3 a side view of the handle device according to the invention with the handle device in the operating position in a sectional view,

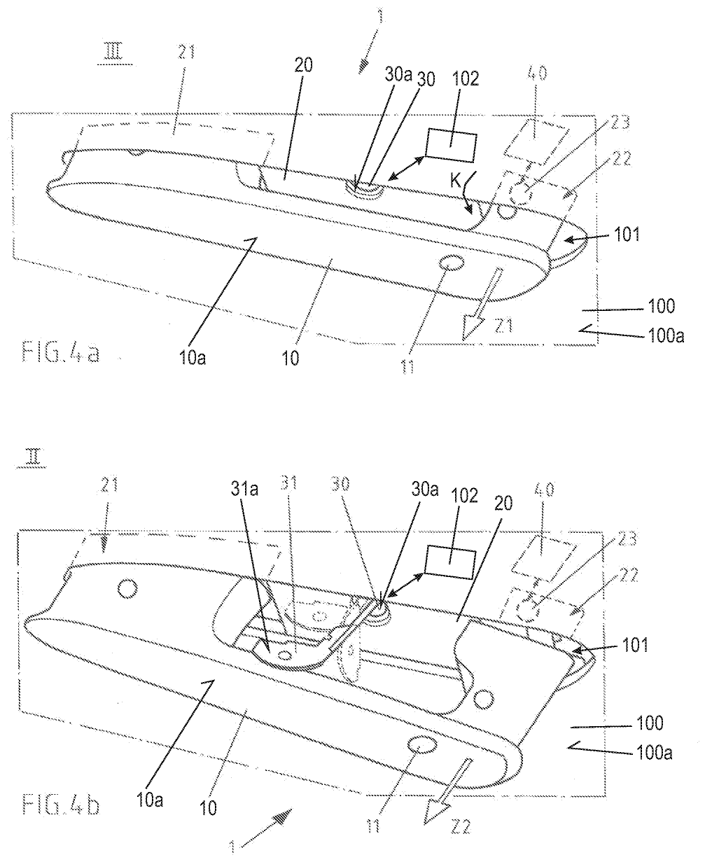

FIG. 4a a perspective view of the handle device according to the invention with the handle device in an intermediate position, and

FIG. 4b a perspective view of the handle device according to the invention with the handle device in the operating position.

In the figures, the same reference signs are used for the same technical characteristics even for different embodiments.

FIG. 1 shows an invented handle device 1 for a movable part 100, in particular a door 100, of a motor vehicle. For reasons of simplicity, the entire motor vehicle is not shown. The handle device 1 is configured with a handle device 10, in particular flush with the surface, for actuating the movable part 100 and a support element 20, on which the handle device 10 is movably mounted between a rest position I and an operating position II.

In FIG. 1, the handle device 10 is schematically indicated by an dashed line, with the handle device 10 in the resting position I In the rest position I, the handle device 10 can be arranged flush with an outer surface of 10a to an outer surface of 100a of the movable part 100.

FIG. 2 below shows the handle device 10 in operating position II. In operating position II the handle device 10 can be moved out of an opening 101 in the outside 100a of the movable part 100, whereby in operating position II the handle device 10 can be actuated to open the movable part 100 by pulling Z2 or by a second pulling movement Z2.

FIG. 1 also shows schematically that a first bearing position 21 and a second bearing position 22 are provided on the support element 20, at which the handle device 10 is movably mounted between the rest position I and the operating position II. In conventional handle devices there is often no space in the area of the two bearing positions 21, 22 to accommodate a mechanical emergency locking cylinder for a mechanical actuation of a locking system 102 of the motor vehicle. Despite a lack of space at the two bearing positions 21, 22 on the support element 20, the inventive handle device 1 enables mechanical unlocking of the locking system 102 of the motor vehicle at least in an emergency. The invention lock cylinder 30 is arranged between the first bearing position 21 and the second bearing position 22 on the support element 20, preferably at an angle to the outside 100a of the movable part 100.

The locking cylinder 30 is concealed behind the grip area of the handle device 10 in the rest position I of the handle device 10. For this reason, the handle device 10 in FIG. 1 is shown dashed so that the locking cylinder 30 appears in the position between the first bearing position 21 and the second bearing position 22 on the support element 20. Thus, a handle device 1 can be provided, which in the rest position I of the handle device 10 can meet high demands on configuration and aerodynamics.

In operating position II of handle 10, the locking cylinder 30 is exposed by handle 10, as shown in FIG. 2. In operating position II of handle device 10, the locking cylinder 30 can be actuated by an emergency key 31, which is, for example, brought along by a first responder, in order to unlock the locking system 102 of the motor vehicle and then to open the movable part 100. This enables the handle device 1 which, in the operating position II of handle device 10, can enable simple operation of the 102 locking system of the motor vehicle and intuitive operation of the 100 movable part to open it.

FIG. 2 also shows that the locking cylinder 30 can be arranged diagonally to the outside 100a of the door 100, 100a, in order to be able to insert an emergency key 31 more easily into the locking cylinder 30, advantageously past the handle device 10 in the operating position II and preferably with a gap S of at least 1 mm between the handle device 10 and the emergency key 31. An angled bearing of the locking cylinder 30 can enable the emergency key 31 to be inserted into the locking cylinder 30 without interference despite a lack of space between the handle device 10 and the locking cylinder 30, even in the operating position II of the handle device 10. The emergency key 31 can also be inserted at an angle to the outside 100a of the movable part 100, preferably along an axis of rotation D of the locking cylinder 30.

An angled position of the locking cylinder 30 means, in the scope of the invention, that the axis of rotation D of the locking cylinder 30 can extend at an angle α of at least 20°, in particular of at least 25°, to a horizontal H which is substantially perpendicular to the outside 100a of the movable part 100. Advantageously, with such an angle α, sufficient space can be provided between the handle device 10 in operating position II and the locking cylinder 30 in order to be able to insert the emergency key 31 into the locking cylinder 30 without interference, advantageously past the handle device 10. With an angle α of approx. 25°, good freedom of movement can be provided for inserting the emergency key 31 into the locking cylinder 30 and easy installation of the locking cylinder 30 on the support element 20, even in such an angled position.

In addition, the locking cylinder 30 can be aligned in such a way that the emergency key 31 can be inserted into the locking cylinder 30 with a gap S of at least 1 mm, in particular of at least 2 mm, and passed past the handle device 10 in the operating position II. Such a gap S can advantageously ensure that the emergency key 31 cannot touch the handle device 10 and scratch it when it is inserted into the locking cylinder 30. The gap S can be adjusted in such a way that an first responder can easily insert the emergency key 31 past the handle device 10, without, however, having to mount the locking cylinder 30 so obliquely on the support element 20 that mounting is associated with difficulties. With the help of an adjusted gap S, a balance can be achieved between a good insertability of the emergency key 31 into the locking cylinder 30 and a excessively angled bearing of the locking cylinder 30 on the support element 20. With a gap S of approx. 2 mm, it is advantageous to ensure sufficient freedom of movement even for correction movements when inserting the emergency key 31 into the locking cylinder 30.

As is also indicated in FIGS. 1 and 2, the locking cylinder 30 can be mounted on the support element 20 in such a way that a rotary movement of at least 1° to 180° of a cylinder core of the locking cylinder 30 can be permitted to actuate the locking cylinder 30. One end face 30a of the locking cylinder 30 may be partially concealed under the outer face 100a of the movable part 100 and only one other part may be exposed through the opening 101 in the outer face 100a of the movable part 100. With such a bearing of the locking cylinder 30, a larger angle α can be set between the rotation axis D of the locking cylinder 30 and the horizontal H in order to improve the accessibility of the locking cylinder 30. The gap S between the handle 10 and the locking cylinder 30 for inserting the emergency key 31 into the locking cylinder 30 can also be enlarged to provide more freedom of movement for the emergency helper. A rotation of the locking cylinder 30 of at least 1° to 180° is preferably sufficient to enable stable operation of the locking system 102 of the motor vehicle, e.g. via gear G, as shown in FIG. 3 below. Here it is conceivable that the emergency key 31 can be inserted with a flat side 31a into the locking cylinder 30, whereby in the inserted position the emergency key 31 can finally be turned, preferably from at least 1° to 180°. It is conceivable that the locking cylinder 30 can only be configured for unlocking the locking system 102 of the motor vehicle. Thus, the locking cylinder 30 and gear G can only be configured to unlock the locking system 102 in an emergency, but not for normal operation, making the handle device 1 simpler and more compact.

FIG. 3 shows gear G, which can be brought into a mechanical active connection with the locking system 102 of the motor vehicle. It is conceivable that gear G may be self-locking. Gear G has a drive wheel G1 which is arranged on the axis of rotation D of the locking cylinder 30 and can be rotated with the cylinder core of the locking cylinder 30. In addition, gear G has an output wheel G2, which can be operatively connected to the locking system 102 of the motor vehicle. It is conceivable that the input wheel G1 and the output wheel G2 can be arranged at the same angle α of at least 20° to each other, in particular of at least 25°. Thus, an angular arrangement can be provided between the rotary axis D of the locking cylinder 30 or the rotary axis of the input wheel G1 and an output axis of the output wheel G2. Consequently, the locking cylinder 30 can be placed in an inclined position to the outside 100a of the movable part 100 and still provide a reliable transmission of action to the locking system 102 of the motor vehicle. In accordance with an configuration of the invention, drive wheel G1 and output wheel G2 can each have conical toothing 32, 33, so that the surfaces of the teeth on drive wheel G1 and output wheel G2 can come into full surface contact with each other during combing, in order to enable efficiency transmission from locking cylinder 30 to locking system 102 with a high degree of efficiency.

FIGS. 1, 4a and 4b further show that a sensor element 11 can be provided on the handle device 10, preferably adjacent to the second bearing position 22 on the support element 20, in order to detect an activation action, advantageously a pressing, of a user, in particular a first responder. Advantageously, the sensor element 11 can be passive, e.g. as a capacitive sensor, a pressure sensor, an inductive sensor, an NFC sensor or an LDC sensor. Since a user is familiar with gripping different handle parts 10 usually at the right end, a sensor element 11 adjacent to the second bearing position 22 can enable intuitive operation of the grip device 10.

FIG. 4a shows handle device 10, which is in an intermediate position III, in which handle device 10 is released for transfer to operating position II, e.g. by a locking element 23. It is conceivable that during normal operation of the motor vehicle, the locking element 23 can hold the handle device 10 in the rest position I and/or establish a connection of the handle device 10 to a drive device 40, as indicated by the dashed arrow in FIG. 4a. Normally, the actuator 40 can be used to automatically drive the handle 10 between the rest position I and the operating position II. In an emergency, the locking element 23 can release the handle device 10 from the rest position I towards the operating position II and/or release the connection of the handle device 10 to the drive device 40, so that the handle device 10 can tilt and/or swivel and/or jump open into the intermediate position III, in particular independently. It is conceivable that the handle device 10 can be pretensioned in the direction of operating position II or in the direction of intermediate position III, e.g. with the aid of a spring element not shown.

In order to transfer handle device 10 to intermediate position III, a user, e.g. a first responder, can first press on sensor element 11 in a first step a), which can be operatively connected to locking element 23. The handle device 10 can then be released by the locking element 23, as previously described. A released handle device 10 can perform a tilting movement K outward from the rest position I of FIG. 1 to the intermediate position III of FIG. 4a.

In this intermediate position III, the handle device 10 stands slightly away from the outside 100a of the movable part, so that in a second step b) the first responder can grip the handle device 10 and in a third step c) pull the handle device 10 in order to perform a first pull movement Z1 between the intermediate position III and the operating position II and thus to transfer the handle device 10 from the intermediate position III to the operating position II.

In operating position II, shown in FIG. 4b, the locking cylinder 30 is exposed so that in a fourth step d) the first responder can operate the locking cylinder 30 with an emergency key 31 in order to mechanically unlock the locking system 102 of the motor vehicle.

Then, when the locking system 102 has been unlocked, the movable part 100 can be opened by a second pulling movement Z2 on the handle device 10. The invention can thus be used to consciously, step by step and carefully operate the handle 1 to open the movable part 100.

The preceding explanation of the embodiment describes the present invention exclusively in the context of embodiments. Of course, individual features of the present invention can be freely combined with each other without leaving the scope of the present invention/claims, if technically reasonable.

### REFERENCE CHARACTER LIST

1 Handle device
10 Handle device
11 Sensor element
20 Support element
21 First bearing position
22 Second bearing position
23 Locking element
30 Locking cylinder
30a Front side
31 emergency key
31a Flat side
32 Conical toothing
33 Conical toothing
40 Drive device
D Axis of rotation
G Gear
G1 Drive wheel
G2 Output wheel
H Horizontal
K Tilting movement
Z1 Pull, first pull movement
Z2 Pull, second pull movement
α Winkel
100 Movable part, door of a motor vehicle
100a Outside
101 Opening
I Rest position
II Operating position
III Intermediate position

1. A handle device for a movable part of a motor vehicle, with
a handle device for actuating the movable part,
and a support element, on which the handle device is movably mounted between a rest position and an operating position,
wherein in the rest position the handle device can be arranged with an outer surface flush with an outer side of the movable part,
in the operating position, the handle device being movable out of an opening in the outside of the movable part,
the handle device being operable in the operating position to open the movable part,
and wherein the support element has a first bearing position and a second bearing position for the handle device,
wherein
a locking cylinder is provided for unlocking the movable part at least in an emergency, which can be brought into a mechanical operative connection with a locking system of the motor vehicle,
the locking cylinder being mounted on the support element between the first bearing position and the second bearing position.

2. The handle device according to claim 1, wherein
the locking system is configured as a keyless go system or a keyless entry system.

3. The handle device according to claim 1, wherein
the locking cylinder is positioned such that, in the rest position of the handle device, the locking cylinder is covered by the handle device and is inaccessible from the outside.

4. The handle device according to claim 1, wherein
the locking cylinder is mounted obliquely to the outside of the movable part.

5. The handle device according to claim 1, wherein
the locking cylinder is aligned in such a way that an emergency key, when inserted into the locking cylinder, can be guided past the handle device in the operating position with a gap of at least 1 mm.

6. The handle device according to claim 1, wherein
the locking cylinder is positioned such that an emergency keys can perform a rotary movement of at least 1° to 180° when the locking cylinder is actuated.

7. The handle device according to claim 1, wherein
the handle device, preferably adjacent to the second bearing position, has a sensor element in order to detect an activation action of a user.

8. The handle device according to claim 1, wherein
the handle device is secured on the support element in such a way that the handle device can be released from the rest position in the direction of the operating position by gripping an activation action of a user, in order to be able to transfer the handle device into the operating position by pulling on the handle device.

9. The handle device according to claim 1, wherein
a locking element is provided at least for holding the handle device in the rest position or for producing a connection of the handle device to a drive device in order to drive the handle device between the rest position and the operating position,
the sensor element preferably being operatively connected to the locking element in order to release the handle device from the rest position in the direction of the operating position in an emergency by detecting an activation action of a user.

10. The handle device according to claim 1, wherein
the handle device is mounted on the support element in such a way that the handle device can be transferred from the rest position into an intermediate position, in which the handle device is released for transfer into the operating position, by sensing an activation action of a user.

11. The handle device according to claim 1, wherein
a transmission is provided in order to establish a mechanical operative connection between the locking cylinder and the locking system of the motor vehicle.

12. The handle device according to claim 1, wherein
the transmission has a drive wheel, and an output wheel,
preferably at least the drive wheel or the output wheel being arranged at an angle of at least 20° to one another.

13. The method for emergency actuation of a handle device for a movable part of a motor vehicle the handle device being provided with
a handle device for actuating the movable part,
a support element, on which the handle device is movably mounted between a rest position and an operating position,
wherein in the rest position the handle device can be arranged with an outer surface flush with an outer side of the movable part,
in the operating position, the handle device being movable out of an opening in the outside of the movable part,
the handle device being operable in the operating position to open the movable part,
and wherein the support element has a first bearing position and a second bearing position for the handle device,
and a locking cylinder for unlocking the movable part at least in an emergency, which can be brought into a mechanical operative connection with a locking system of the motor vehicle,
wherein
the method comprises the following steps:
a) detecting an activation action of a user on the handle device in order to release the handle device from the rest position in the direction of the operating position,
b) gripping the handle,
c) pulling the handle device to transfer the handle device to the operating position,
d) inserting an emergency key into the locking cylinder to unlock the movable part.

14. The method according to claim 13, wherein
in step a), an activation action of a user is detected by pressing on the handle device.

15. The method according to claim 13, wherein
the process comprises at least one further step:
a1) releasing a locking element which at least holds the handle device in the rest position or establishes a connection of the handle device to a drive device which moves the handle device during normal operations between the rest position and the operating position.

16. The method according to claim 13, wherein
the process comprises at least one further step:
a2) transferring the handle device from the rest position into an intermediate position, in which the handle device is released for transfer into the operating position.

17. The method according to claim 13, wherein
the process comprises at least one further step:
e) pulling the handle device to open the movable part.

18. The handle device according to claim 6, wherein
the locking cylinder being positioned in such a way that the locking cylinder can serve to unlock the locking system of the motor vehicle.
